(19) United States
(12) Patent Application Publication
(10) Pub. No.: US 2010/0233956 A1
(43) Pub. Date: Sep. 16, 2010

(54) Method and Appliance for Communication Between a Multiplicity of Mobile Stations and a Fixed Network Underground

(75) Inventor: Christoph Hunziker, Oberentfelden (CH)

Correspondence Address: THE WEBB LAW FIRM, P.C., 700 KOPPERS BUILDING, 436 SEVENTH AVENUE, PITTSBURGH, PA, 15219, US

(73) Assignee: LICANIA GMBH, Oberentfelden (CH)

(21) Appl. No.: 12/293,780

(22) PCT Filed: Mar. 19, 2007
(86) PCT No.: PCT/CH2007/000150

§ 371 Date: Sep. 19, 2008

(30) Foreign Application Priority Data
Mar. 21, 2006 (CH) 439/06

(51) Int. Cl. H04B 7/26

(52) U.S. Cl. 455/40

(57) ABSTRACT

A method for wireless underground data transmission between a large number of mobile stations and a fixed network involves the mobile stations being stored in depersonalized form, advantageously in a loading station. Upon removal, the mobile stations are personalized using a personalization device associated with the mobile station, for example by inputting a code or by an RFID card arranged close by which makes contact with the mobile station without touching it, so that said mobile station can also be reached by means of a personalized user identifier in addition to the associated appliance-specific identifier. Following use, each mobile station is depersonalized using the personalization device associated with the mobile station when it is returned to the storage station.

The invention relates to a method and an appliance for wireless underground data transmission between a multiplicity of mobile stations and a fixed network.

The mobile telephone has long ago become a constant part of everyday life. In underground areas, on the other hand, employees are often unreachable for an entire shift, which often results in delays, unnecessarily increased costs and production losses.

For voice communication in office environments and increasingly also in the private sector, the “VoIP” (“Voice over IP”) method is being used to an ever greater extent, wherein the transmission medium used is Ethernet or wireless Ethernet (“WLAN”). This is also already the case in some installations in mines.

The method presented here describes the communication of employees and machines underground with one another and with central devices. It assumes that a mine is equipped with a fixed digital communication infrastructure. This may be based on mobile radio techniques (GSM, UMTS) or else on wireless network techniques (such as “WLAN” based on IEEE 802.11 or WiMAX).

If the employee underground actually has a communication link and an appropriate appliance, this appliance can also perform other functions besides the pure telephony application, and this is what needs to be protected by means of this invention: the associated appliance is a personal or machine-based communication and computation platform which, in various embodiments as an underground-compatible mobile telephone, as a built-in appliance for machines and as a “wearable device”, may be incorporated in articles of clothing, in the helmet or in a miner's lamp. This appliance performs not only telephony and/or the interchange of data-based short messages but also the supplementary functions of the mobile part for the communication system which are described in the method. These supplementary functions turn a “regular” mobile telephone into an appliance which can be used underground and additionally provides an application-specific additional value and assists the miner in his individual daily work. Such functions are, by way of example but not exclusively:
use of the mobile parts by different people and personalization of the appliances at the start of a shift emergency functions which allow a mine to be evacuated specifically
“location based services”, which warn the user about temporary or permanent risks and possibly provide measured values (e.g. gas concentrations etc.) on the basis of location underground
functions for collaboration in workgroups (e.g. “duplex functions”)
availability on different numbers on one appliance (e.g. one number for the “work area” or the machine and another personal number for the user)
control functions for machines
individual computation applications for the individual employee's workplace.

The fundamental method for setting up a wireless underground data transmission can also be summarized or characterized as follows:
every usable mobile station is stored, prior to its use, in an inoperative station in a storage station, advantageously in a charging station,
during or after removal of the mobile station, a user is identified on the storage station or on the mobile station,
a user identifier for an appliance identifier of the mobile station is implemented in a central server,
the appliance or parts of the appliance is/are enabled by an enable code from the central server or by the subsequent transmission of the user-related information,
additionally user-related information or programs can optionally be transmitted from central systems to the mobile station before or during use of the mobile station,
at the end of use, user-specific information is transmitted back to the central system or deleted and the user association in the central system itself is deleted when the mobile station is returned to the storage station; or for example, it makes sense for the user-specific information to be deleted when it is unalterable or unaltered profile information.

User-related information may be, in particular, outputtable information individually associated with the relevant person himself or associated with workgroups or associated with work locations, which information comprises, by way of example, a user profile which is transmitted simultaneously with or for the purpose of enabling to a mobile station.

The method describes firstly the use of the appliances and secondly the functionality of the overall system, which is closely related to the use.

For use of the method, two different methods are distinguished:

1. The employee uses a personal appliance which is associated with him for an entire shift (in a similar manner to a filter self-rescuer or a miner's lamp).
2. The employee (e.g. a “machine operator”) uses a permanently installed (e.g. on a machine) communication appliance. In this case, it may be that the machine operator changes machines during a shift.

A common feature of both methods is the practice that an appliance according to the invention needs to be available for communication underground.

The cycle of use comprises four steps:

1. Previous and/or subsequent use of charging devices for the personal communication appliances above ground (dispensed with in the case of fixed appliances or appliances permanently incorporated in machines)
2. Personalization of an appliance for use or association of an appliance with an individual person for use: a) enabling of the appliance or parts of the appliance by an enable code, e.g. from a central computer, which prevents the appliance from being used without authorization (for example “at home”); b) transmission of user-specific programs and settings to the appliance from a central computer.
3. Use of the appliance, possibly observing data-protection anonymization routines to prevent “person tracking” in normal operation.
4. Depersonalization following use or transmission of the personal settings back to the server and deactivation of the appliance by breaking the connection to a specific user following use.

If the appliance is put back into the charging station after a particular time and hence there is no official depersonalization, the appliance can stop working, since it has to assume that it is being misused (for example “at home”). This effectively prevents the theft of appliances, which is very common in mining.

Since it is difficult to permanently associate an appliance with one person during the day and it is always necessary to ensure that the staff begin work with fully charged appliances, central charging devices are provided above ground. These charging devices charge the mobile telephones (the storage batteries therein) either by means of electrical contacts or wirelessly (inductively).

When an appliance is removed from the charging device, the removing employee needs to be personally associated with the appliance, which is called personalizing the appliance. In fact, this does not involve the appliance itself being “personalized”—it can always be reached via its network address. Rather, this operation involves the telephone number of the employee being logically combined with the hardware or network address of the telephone in a central computer. This can also be done by diverting the “normal” office telephone number to the network address of the underground telephone, for example in the telephone system or in a central computer. This provides the appliance with its virtual “telephone number”, on which it can be reached during working time. This personalization can be effected either by means of the input of an identifier together with a PIN code on the telephone itself or else electronically using supplementary appliances: these may be in a form such that the employee inserts his personal electronic identification chip (“RFID chip”, “personnel card” etc.) at the same time as the telephone into an electronic appliance which then configures the mobile telephone for the employee.

This “personalization appliance” may also be combined directly with the charging station or networked thereto. This means that the charging station would enable an appliance for use mechanically only if the personalization has been performed successfully.

The configuration can proceed as follows:

1.) The charging station selects a suitable mobile telephone on the basis of the criteria of charge state and frequency of use: in this case, a fully charged telephone which has not be used for the longest is preferred, for example.
2.) The mobile telephone or the personalization appliance informs the central server of the data from the employee to be associated.
3.) The central server associates a telephone number for the employee with the address of the mobile telephone. Thereafter, the telephone can be reached on this number. If a conventional telephone number possibly exists for the employee, the server can prompt this telephone number to be diverted to the mobile telephone in the telephone system.

During personalization, further use-dependent information and programs are also simultaneously loaded from central server systems. Examples of such information may be:
current general works shift information of all kinds which can be displayed on the mobile telephone in the form of text messages. The employee reads these notifications and has information about the most up-to-date works notifications. In this case, individual notifications can be stored for various individual users and limited user groups.
information about the specific employee's area of responsibility and work to be performed etc., which is loaded onto the mobile telephone in the form of text messages: work schedules, handover notifications etc.
general safety and works information, such as “shaft 7 closed for maintenance”
news and other types of notifications to which the employee has “subscribed” for his individual use in the network.
association with particular PTT groups (Push-to-Talk groups).
application programs which are required for assisting the employee activity. Hence, by way of example, different programs for logistics employees, machine operators, foremen, etc. are loaded onto the communication appliance. This turns the telephone into a microcomputer which performs limited auxiliary functions from the user's area of work or accepts the user's dialogue with his machine, for example. These programs can then also allow network access to central information. The technologies to be used for this purpose correspond to those of “Internet mobile telephones”.

The personalized mobile station associates this appliance with a person. The relevant person may be associated with a workgroup receiving specialist information in databases belonging to the employer; alternatively, he may have a particular association with a work location for one day, so that in this case only such information relating to a certain section underground is transmitted. The same applies for loadable programs. Instead of the loading operation, provision may also be made for stored programs to be enabled.

In the case of permanently incorporated appliances (e.g. in machines), personalization is sometimes not necessary, since the appliances are associated with a machine and hence not with a person. If provision is made for personalization, this can naturally only be done when the user of the machine has arrived on the machine. The following personalization process then takes place:

1. Before the machine operator can start up the machine, he needs to identify himself on the communication appliance by inputting an identifier (e.g. personnel number) and a PIN code, for example.
2. It is possible to dispense with input of the identifier if electronic auxiliary means (e.g. an RFID-based personal electronic identification card) are being used. If this is the case, the communication appliance can be automatically configured for the employee for as long as his identification card is inserted in a reader or for as long as the RFID tag of the employee is within range of the communication appliance.
3. Optionally, the communication appliance enables the machine (e.g. via a field bus, network or a digital signal) following identification.
4. If identification does not take place or if it is not necessary, the machine operator can be reached only on the telephone number of the machine while he is using the machine.
5. If identification does take place, a central server is used to configure the telephone number of the employee into the appliance or in the server, and the employee can be reached on his number on this appliance for as long as he is using the machine (until he “logs out”). In this case, he can use the same functions and individual configurations and programs as is the case for a mobile appliance.
6. During his work, the employee can now be reached either on the telephone number of the machine or on his personal telephone number, provided that the machine is within range of the wireless network.
7. At the end of the shift, the user either logs out or simply removes his electronic identification card from the reader, or he withdraws for a relatively long period from the range of the RFID reader. Alternatively, he simply puts the appliance into the charging unit in order to depersonalize it.

The method uses the wireless infrastructure in the underground structure to transmit data, pictures, videos and telephone calls to a mobile terminal in bundles and in digital form.

The method will require an underground network infrastructure for which wireless access is also available with complete or partial coverage.

The method combines the basic function of wireless telephony with supplementary and safety functions for duplex, positioning and, by way of example, as a “dead-man's switch” for underground operation, such as:
All appliances or selected appliance groups switchable to announcement mode “broadcast”. In this case, the groups can be selected and activated either on the basis of task or on the basis of locality. Used for task-specific or use-location-specific communication of messages. This means that in emergencies, for example, pit areas can be evacuated or employees can be advised of risks which arise. The task-specific notification allows service employees, for example, to be addressed specifically, for example in order to allow fault diagnosis in the extensive pit structures to be performed specifically and quickly.
What goes for the announcements applies in the same way to notifications too, e.g. in text or picture form.
Option of having text messages read aloud by means of voice synthesizer. This may be useful, since frequently both hands are used for the work and hence an appliance cannot be used immediately.
Light signals for signaling notifications or calls (miner's lamp flashes) or a separate light in or outside the appliance is activated.
Vibration alarm.
Acknowledgement button for acknowledging notifications which have been received by voice or data message. The acknowledgements are collected on a central computer and are used by the control station personnel for monitoring purposes.

“Sign-of-life reports”: an integrated motion sensor establishes when the appliance and hence the person have not moved over a particular period. An alarm is then initiated on the appliance itself. If this alarm is not acknowledged by the associated person, an alarm is initiated in the control room and is connected to a position report by means of the infrastructure in order to find an injured person, for example, in an emergency.
Link to machines and appliances: appliance tracking through regular reports from the appliance to a central computer or by virtue of the appliance being tracked via the infrastructure. This allows the appliance to be used as a train radio telephony system for underground facilities, for example.
Interfaces between the appliance and the machine: enable the machine to start following login, emergency alarm, call signaling, “Message received” signaling.
Since a display is required for the text messages and for operation, the display on machines can also be used on a multifunctional basis: the method provides for the communication appliance to be able to execute various application software which allows the appliance to be used as a simple operator control terminal for a machine or for selected machine functions too, for example.
Incorporation of the appliance into “wearable” devices, such as into a headset (combination of headphones, microphone and possibly camera) or into the helmet or battery part of a miner's lamp and possibly into articles of clothing.
Variant with camera in order to be able to “capture” situations during operation and later transfer them to a computer and in order to forward these pictures directly to colleagues (e.g. for spares purchase and for fault diagnosis).
“PTT” function: duplex function (PTT for Push-To-Talk), which allows either duplexing at the push of a button (“half-duplex operation”) or a conference call with another or with several employees who are working on a common task simultaneously, this task being performed by various people working at various locations outside the call range (e.g. on a belt system which may be kilometers in length or in a strut which is several hundred meters in length). This function can be set up using the telephone software. In particular, the voice for this function can be transmitted over GPRS connections, for example.
Remote monitoring of the “mobile phone” batteries by a control station, so that it is possible to distinguish whether a mobile phone is switched off or “dead”.
Replacement of the mobile phone batteries underground (for example for long shifts).
Re-personalization underground (in special cases).

Emergency key (key-in function): pressing the key for a relatively long time (e.g. for more than three seconds) results immediately in setup of a maximum-priority telephone connection to a central station at which the location of the reporting person is also immediately indicated. In this mode of operation, a full-duplex connection is produced between the operations center and the reporting terminal.

In addition, a method can be chosen as follows: two or more appliances are interconnected in fixed groups (e.g. configured by means of a database) or dynamically (see below) to form “PTT” groups. In this sense, PTT means pure simplex in half-duplex mode or telephone conferencing in full-duplex mode.

Simplex mode is still preferred by most users even today, since the loudspeaker is muted when no-one is operating the talk key or the talk key is being operated under voice control by one's own voice. This means that the user also does not have to listen to (sometimes very loud) ambient noise from motors and machines so that he needs to painstakingly filter out the voice of a colleague therefrom.

In this case, the method proceeds as follows:

### Group Selection

1. Alternative 1: static configuration of a PTT group: the telephone's menu is used to select a prepared group which is stipulated in files or databases on a central server. All subscribers in a group select the group and are then connected to one another by simply pushing the talk key: one pushes the talk key and all the others hear the speaker.
2. Alternative 2: dynamic configuration of a PTT group: the group meets (e.g. prior to use) at a common point—e.g. close to a common access point. To form the group, everyone simultaneously pushes a key (e.g. the talk key) for at least three or five seconds, for example.

The central computer or the access point or else the appliances without central assistance among one another recognize this and connect to one another automatically in a “PTT group”. This selection can be automatically refreshed, for example when employees are close to such an access point only temporarily for work purposes.

3. Alternative 3: manual configuration: the telephone numbers of the subscribers in a PTT group are input manually or selected from a menu in every telephone.

The successful formation of a PTT group is acknowledged audibly and/or visually by the telephones. The active group is indicated in the display.

A plurality of PTT groups may be activated simultaneously in one telephone.

For supervisory personnel, a plurality of PTT groups may be activated which are activated only for the purpose of listening in. If sending takes place in a plurality of groups simultaneously, the employee hears only the voice from that group to which he himself has allocated the highest priority.

### Duplex Mode

Once the group setting has been made, the people separate and distribute themselves for their common work, e.g. on a long conveyor line, in mining or in the tunnels (routes). Whenever they are in range of radio coverage, they have access to the common radio network in the group:

In duplex mode, a person pushes the talk key (as on a radio set) and all the other appliances in the group hear the voice of the speaker.

All the appliances in a PTT group therefore effectively operate on a “virtual radio channel” within the “wireless” and wired network.

Pushing the talk key can also be replaced by voice control, which automatically activates the talk function when talking loudly. This can be selected in a menu.

If required (e.g. for safety-critical operations), the voice radio traffic can be recorded at a central station (server), in a similar manner to in the case of the fire brigade and police. In the event of an accident, the recordings can then be played back subsequently by authorized people.

In technical terms, a PTT group is preferably set up on the basis of the following method:

1. Since the central telephony server is usually already able to form telephone conferences, a PTT group is set up in the central computer as a telephone conference. This has the advantage that the telephone does not require any kind of hardware changes.
2. In the telephone itself, the microphone is muted in PTT mode in order to prevent all subscribers in the group from being permanently overloaded with all the ambient and operating noise.
3. When a subscriber pushes his talk key on the mobile appliance, on the headset or activates the voice channel by means of a voice-controlled microphone, his voice is enabled and transmitted to all the subscribers in the PTT group.

For safety-critical applications, a recording function (“Voice-Recorder”) for PTT groups may also be set up in the central server if appropriate.

### Deactivation

Every subscriber in a group can explicitly log off from the group using the menu.

### Application Programs

Every user underground has a particular area of responsibility with individual deployment tasks. Often, it would make sense if these work tasks could be supported by simple computer programs. This applies to the underground surveyors (mine surveyors) or else to maintenance personnel and electricians, for example:

These and others can load specific application programs created for their personal field of activity onto their communication appliance. This loading of the programs can take place automatically before the start of the shift directly when the telephones are personalized; they may also be stored in a memory provided in the mobile station, and the loading is then replaced by the relevant directories and authorizations for executing these programs (which are then in place) being enabled.

Examples of such applications may be:
Mine surveyors are provided with surveying programs and data acquisition programs installed on the appliance, which can show data required for the surveying from central databases and can forward freshly acquired survey data to the databases.
In similar fashion to the way in which a mobile telephone is used to set up an Internet connection, maintenance personnel can retrieve information from central databases and send spares orders, for example. At the same time, computation functions are available in the appliance.
On machines on which a display is (possibly consciously) omitted, a program on the mobile telephone of the machine operator can show reports from the machine which are transmitted to the mobile telephone of the operator via the wireless network. This may sound somewhat complicated, but may make a great deal of sense under the prevailing environmental conditions, since permanently installed appliances are often a match for the ambient conditions in only a very short time.

In many cases, the machines are also so large (e.g. ploughing systems or conveyor lines) that the users or the maintenance personnel do not (have the ability to) stay on the machine itself at all. In this case, the mobile telephone of the user or of the maintenance staff can be used to show operational information, warnings, alarms and maintenance reports.

Since charging the batteries using contacts is very error-prone, contactless inductive transmission of the charging current is preferred for the appliance.

1-15. (canceled)

16. A method for wireless underground data transmission between a multiplicity of mobile stations, each having at least one transmission and reception device, and a fixed network data transmission between the mobile station and the fixed network takes place wirelessly via at least one base station and each mobile station is reached by means of an appliance-specific identifier associated with the respective mobile station, the method comprising the steps of:
depersonalized storage of every mobile station, prior to its use, in a storage station;
personalization of every mobile station before, during or after removal from the storage station by means of a personalization device associated with the mobile station, so that said mobile station can be reached not only by means of the associated appliance-specific identifier but also by means of a personalized user identifier; and
depersonalization of every mobile station upon return to the storage station by means of the personalization device associated with the mobile station.

17. The method as claimed in claim 16, wherein the mobile station is incorporated in a moving or nonmoving machine and personalization is performed when the machine is switched on, or combined depersonalization and re-personalization is performed upon shift handover.

18. The method as claimed in claim 17, wherein one of the mobile station and the moving or nonmoving machine has its functions enabled only after successful personalization of the mobile station.

19. The method as claimed in claim 16, wherein the personalization is performed by transmitting a personal user identifier to the mobile station, the personal user identifier comprises a user-specific code which needs to be input by a user or which can be transmitted electronically.

20. The method as claimed in claim 16 wherein every personalized mobile station, upon personalization, has outputtable information, individually associated with one of a relevant person, workgroups or work locations, and executable programs transmitted and loaded into an existing volatile or nonvolatile memory in the mobile station.

21. The method as claimed in claim 16, wherein the mobile station is enabled by virtue of a transmission of user-related information by one of the personalization device and a base station.

22. A method for wireless underground data transmission between a multiplicity of mobile stations, each having at least one transmission and reception device, and a fixed network, data transmission between the mobile station and the fixed network takes place wirelessly via at least one base station, and each mobile station is reached by means of an appliance-specific identifier associated with the respective mobile station, the method comprising the steps of:
one of continuously or intermittently detecting movements by the mobile station using a motion sensor of the mobile station, the motion sensor controlled by a controlled device; and
transmission of an automatic alarm by the control device to the fixed network if movements of the mobile station are absent over a predetermined period of time.

23. The method as claimed in claim 22, wherein the control device sends the fixed network, in combination with or at the same time as an alarm, an externally perceptible visual, audible or mechanical warning which invites the user of the mobile station to acknowledge the alarm, wherein the control device transmits the result thereof to the fixed network to handle or activate the alarm or initiates an alarm only if the acknowledgement function is not activated.

24. The method as claimed in claim 23, wherein every mobile station, upon personalization, has outputtable information, individually associated with one of a relevant person, workgroups, work locations and executable programs transmitted and loaded into an existing volatile or nonvolatile memory in the mobile station.

25. The method as claimed in claim 24, in which user-related information present on the mobile station is deleted during depersonalization or is stored in a personalization device or in a base station.

26. The method as claimed in claim 23, in which the mobile station is enabled by virtue of transmission of user-related information by a personalization device or by a base station.

27. A method for wireless underground data transmission between a multiplicity of mobile stations, each having at least one transmission and reception device, and a fixed network, each mobile station is reached by means of an appliance-specific identifier associated with the respective mobile station, the method comprising the steps of:
wirelessly transmitting data between the mobile station and the fixed network via at least one base station; and
associating at least two mobile stations from a multiplicity of mobile stations with one of a simplex and a PTT group.

28. The method as claimed in claim 27, wherein one of the simplex or PTT group is formed by all mobile stations which are at a predetermined physical distance from an access point, or the simplex or PTT group is stored in predefined fashion in mobile stations which can respectively be selected by manual activation or activated automatically by local dialing.

29. The method as claimed in claim 27, wherein the mobile station is enabled by virtue of transmission of user-related information by a personalization device or by a base station.

30. The method as claimed in claim 27, wherein user-related information present on the mobile station is deleted during depersonalization or is stored in the personalization device or in a base station.

31. A mobile station for communication via a radio network with a fixed network for wireless underground data transmission between a multiplicity of mobile stations and a fixed network, the mobile station comprising:
at least one transmission and reception device which is designed to be able to communicate with at least base stations in the radio network,
wherein the mobile station has a personalization device configured as a radio frequency receiver, which can be switched by a radio frequency tag, for identifying an electronically-transmittable user-specific code.

32. The mobile station as claimed in claim 31, further comprising a motion sensor, controlled by a control device, for continuously or intermittently detecting movements by the mobile station, wherein, if such movements are absent over a predetermined period, then the control device can be used to transmit an automatic alarm to the fixed network.

33. The mobile station as claimed in claim 32, further comprising one of a visual, audible or mechanical indicator provided for external perception of an alarm, and a shorthaul radio transmitter for transmitting a control signal to an external receiver with a visual, audible or mechanical indicator provided for external perception of an alarm.

34. The mobile station as claimed in claim 31, wherein the mobile station additionally has a half-duplex or full-duplex installation for direct communication with adjacent mobile stations.
